(19) United States
(12) Patent Application Publication
(10) Pub. No.: US 2009/0117449 A1
(43) Pub. Date: May 7, 2009

(54) Mixed Feed Direct Methanol Fuel Cell Modified By Semipermeable Membrane For Catalyst Layer

(76) Inventors: Scott Andrew Calabrese Barton, East Lansing, MI (US); Arthur Kaufman, West Orange, NJ (US); Weihua Deng, Overland Park, KS (US); Frank H. Gibbard, Epping, NH (US); Moisey Sorkin, Princeton, NJ (US)

Correspondence Address: BAKER BOTTS L.L.P., 30 ROCKEFELLER PLAZA, 44TH FLOOR, NEW YORK, NY, 10112-4498, US

(21) Appl. No.: 12/239,382

(22) Filed: Sep. 26, 2008

Related U.S. Application Data
(63) Continuation of application No. PCT/US2006/037380, filed on Sep. 25, 2006.
(60) Provisional application No. 60/787,714, filed on Mar. 29, 2006.

(51) Int. Cl. H01M 10/36; H01M 4/86; H01M 4/88

(52) U.S. Cl. 429/41; 502/101

(57) ABSTRACT

Electrodes are used in fuel cells for generating electricity from a mixed feed, where the mixed feed comprises a fuel portion and an oxidation portion. Fuel cells incorporating the electrodes and a method of fabricating the fuel cells are described. In some embodiments, the electrodes comprise a barrier layer (120, 160) having first and second sides, permeable to one of the fuel portion and oxidant portions of the mixed feed, a catalyst layer (130, 150) formed on the first side of the barrier layer, and the reactant distribution layer (110, 170), formed on the second side of the barrier layer.

### CROSS REFERENCE TO RELATED APPLICATION

This application is based on Provisional Application Serial No. 60/87,714, filed Mar. 29, 2006, which is incorporated herein by reference for all purposes and from which priority is claimed.

### STATEMENT REGARDING FEDERALLY SPONSORED RESEARCH

The invention described herein was funded in part by grants from the United States Army Research Office, GRADCO-AO W911NF-05-C-005. The United States Government may have certain rights under the invention.

### BACKGROUND OF THE INVENTION

1. Technical Field. The present invention relates to an improved mixed feed direct methanol fuel cell and, more specifically, to an improved electrode for use in mixed feed direct methanol fuel cells.

2. Background Art

A fuel cell is a device for the production of electricity from chemical reactions of fuel and an oxidizer. Fuel cells have been the subject of recent research because they are highly efficient and produce few pollutants during operation. A typical fuel cell uses hydrogen as the fuel and oxygen as the oxidizer. However, hydrogen is difficult to store safely in quantity and the need to keep fuel and oxidizer feeds separate throughout greatly complicates the construction of fuel cell stacks. Stacking of fuel cells is often required in order to produce the voltage needed to power typical electronic devices.

Recently, mixed feed direct methanol fuel cells (DMFCs) have received more attention for their potential application as alternative power sources, especially for portable electronic devices. Compared to typical fuel cells, DMFCs allow higher energy densities, simpler system design and the use of more reliable liquid feed. A mixed feed DMFC stack does not require separate fuel and oxidant feeds or separator plates, and therefore can be of a more compact design than a typical fuel cell stack. Furthermore, because methanol can be stored in liquid form at room temperature, unlike hydrogen, fuel storage is simpler and safer than in a typical fuel cell.

Referring to FIG. 9, a typical mixed feed fuel cell is composed of multiple membrane electrode assemblies (MEAs) (905). A typical MEA (905) includes seven layers: a proton exchange or polymer electrolyte membrane (PEM) (940), an anode catalyst layer (930), a cathode catalyst layer (950), two reactant distribution layers (920 and 960), and two sealing gaskets (910 and 970).

The proton exchange or polymer electrolyte membrane (PEM) (940) is at the center of the fuel cell. The anode catalyst layer (930) is on one side (941) of the PEM and the cathode catalyst layer is on the other side (942). The resulting three-layer assembly is further sandwiched between the two reactant distribution layers (920 and 960). Finally, the gaskets (910 and 970) are placed on the cell as appropriate to achieve the desired manifolding and sealing arrangement for the MEA (905).

The anode catalyst layer (930) and the adjacent reactant distribution layer (920) form an anode, while the cathode catalyst layer (950) and its adjacent reactant distribution layer (960) form a cathode. Historically, these reactant distribution layers operated by gas diffusion, and were referred to as gas diffusion layers, or GDLs. Because the fuel cell runs on a mixed feed, no separator plates are needed. However, this also means that the anode and cathode are exposed to the entirety of the feed during operation, rather than just the fuel or oxidant, as in a typical fuel cell. The state-of-the-art anode catalyst for DMFCs is a combination of platinum and ruthenium (Pt—Ru). The state-of-the-art cathode catalyst for DMFCs is platinum.

Nafion® materials have been used extensively as polymer electrolyte membranes in DMFCs due to their high proton conductivity (0.100 S/cm in water at 25° C.) and excellent chemical and mechanical stability. Besides acting as proton exchange media, Nafion® has been also used as a binder or modifier to alter the configuration of electrodes in order to obtain a better performance. For example, in Wang, S. et al., Improvement of direct methanol fuel cell performance by modifying catalyst coated membrane structure, Electrochemistry Communications, 2005, 7(10): p. 1007-1012, a method to improve DMFC performance by placing a Nafion® layer between a Nafion® membrane and a catalyst layer of a MEA was reported. In this prior art, a Nafion® layer was introduced to roughen the membrane prior to application of the catalyst layer.

The major technical challenge affecting prior art mixed feed DMFCs is compromised electrode performance resulting from simultaneous reaction of fuel and oxidant at each electrode, resulting in polarization, loss of cell potential, and reduced fuel efficiency. For example, in the methanol anode, a typical prior art Pt—Ru black anode has been shown to be insensitive to the presence of oxygen from air under certain conditions. However, in conditions of lean methanol feed and high temperature, significant polarization due to the presence of air may occur.

Referring to FIG. 10(a), polarization curves for a prior art anode under ideal (solid symbols) and mixed feed (empty symbols) conditions at 70° C. (rectangles) and 80° C. (circles) temperatures are shown. Under ideal conditions in which no oxygen is present at 70° C. (1020) and 80° C. (1010), the open circuit potential (OCV) for the anode is 0.15V, while the OCV increases to 0.62V under mixed feed conditions at 70° C. (1030) and 80° C. (1040), showing the significant effect of the “parasitic” reaction of fuel and oxygen on the performance of the electrode. However, these curves run parallel to each other, reflecting their similar ohmic resistance, which is a property of the MEA itself. The presence of oxygen results in an additional ˜300 mV polarization for the prior art Pt—Ru anode under these circumstances.

Referring next to FIG. 10(b), polarization curves for a prior art anode with different-methanol solution flow rates are shown. As can be seen, under ideal feed conditions in which no oxygen is present (solid symbols), higher methanol flow rates (baseline represented by circles, 2× baseline represented by triangles, and 3× baseline represented by diamonds) improve the anode performance because of an intensified methanol activity. Similarly, the increased methanol concentration has a significant effect in improving anode performance. For example, from the baseline flowrate (1011), the OCV drops to 0.42V and then to 0.38V when methanol flow rate is doubled (1021) and tripled (1031), respectively, as shown. The more methanol in the mixed feed (empty symbols), the greater its presence in the reactant distribution layer, thereby decreasing oxygen access to the electrode. Also represented are the polarization curves for the baseline anode under mixed feed conditions at the baseline (1041), doubled (1051), and tripled (1061) flow rates.

Accordingly, there is a need for an improved mixed feed DMPC that inhibits and/or prevents such parasitic reactions of fuel and oxidant, thereby increasing the performance of the DMFC under ordinary conditions.

### SUMMARY OF THE INVENTION

The present invention provides for electrodes for use in a fuel cell for generating electricity from a mixed feed including at least a fuel portion, such as methanol, and an oxidant portion, such as oxygen, where the electrodes incorporate a barrier layer, permeable to one of the portions of the mixed feed, and relatively impermeable to a different portion of the mixed feed. In some embodiments, the electrodes are anodes, and the barrier layer is permeable to the fuel portion of the feed but relatively impermeable to the oxidant portion of the feed. In some embodiments, the electrodes are cathodes, and the barrier layer is permeable to the oxidant portion of the feed but relatively impermeable to the fuel portion of the feed.

The present invention also provides for fuel cells for generating electricity from a mixed feed including at least a fuel portion, such as methanol, and an oxidant portion, such as oxygen, where the fuel cells incorporate either an anode barrier layer (permeable to the fuel but relatively impermeable to the oxidant) placed between the anode catalyst and the first reactant distribution layer, or a cathode barrier layer (permeable to the oxidant but relatively impermeable to the fuel), placed between the cathode catalyst layer and the second reactant distribution layer, or both an anode barrier layer and a cathode barrier layer. In some embodiments, the fuel cell includes a membrane, an anode catalyst layer, an anode barrier layer, permeable to the fuel but relatively impermeable to oxidant, a cathode catalyst layer, a cathode barrier layer, permeable to the oxidant but relatively impermeable to the fuel, and a first and second reactant distribution layer.

The anode catalyst layer is formed on one side of the membrane, and the first barrier layer is formed on the side of the anode catalyst layer opposite to (i.e. facing away from) the membrane. The first reactant distribution layer is formed on a side of the anode barrier layer opposite to the anode catalyst layer. The cathode catalyst layer is formed on the second side of the membrane (opposite to the anode catalyst layer), and the cathode barrier layer is formed on a side of the cathode catalyst layer opposite to the membrane. The second reactant distribution layer is formed on a side of the cathode barrier layer opposite to the cathode catalyst layer.

Several fuel cells can be stacked on top of each other, sharing reactant distribution layers, in order to form a stack of catalyst coated membranes (CCMs) separated by reactant distribution layers.

The membrane functions as an electrode separator and an ionic conductor, and preferably is a Nafion® membrane.

The reactant distribution layers are formed of a carbon material, such as carbon cloth or paper. In one arrangement, the first reactant distribution layer is carbon cloth treated with a microporous carbon-polytetrafluoroethylene (PTFE, which is commercially available under the trade name Teflon®) layer on a single side, while the second reactant distribution layer is carbon cloth treated with a microporous carbon-PTFE layer on two sides.

The anode catalyst layer preferably utilizes Pt—Ru, and can also include Nafion® to bind the catalyst particles together into a film and provide ionic conduction within the catalyst layer structure. The anode catalyst layer catalyzes the reaction of the fuel. In a preferred embodiment, the anode catalyst layer includes approximately 85 wt % Pt—Ru and 15 wt % Nafion®.

The anode barrier layer can be formed from Nafion® at a loading of preferably 1-10 mg/cm², preferably including a small amount of carbon, e.g., 5-20 wt % carbon black, to reduce ohmic resistance. In a preferred embodiment, Nafion® at a loading of 2 mg/cm² that includes 10 wt % of carbon forms the anode barrier layer.

The cathode catalyst layer preferably utilizes Pt, and can also include Nafion® to enhance performance. The cathode catalyst layer catalyzes the reaction of the oxidant. In a preferred embodiment, the cathode catalyst layer includes approximately 90 wt % Pt and 10 wt % Nafion®.

The cathode barrier layer can be formed from PTFE at a loading of preferably 1-10 mg/cm², preferably including a small amount of carbon, e.g., 5-50 wt % carbon, to reduce ohmic resistance. In a preferred embodiment, a PTFE loading of 2 mg/cm² that includes 25 wt % of carbon forms the cathode barrier layer.

The present invention also provides methods of making a catalyst-coated membrane for use in a mixed feed fuel cell for generating electricity from a mixed feed including fuel and an oxidant. In some embodiments, a method includes applying a first catalyst suspension to a first side of a membrane, drying the first catalyst suspension to form a first catalyst layer on the first side of the membrane, applying a first barrier layer, permeable to the portion of the feed that corresponds to the first catalyst but relatively impermeable to a different portion of the feed, to a side of the first catalyst layer opposite to the membrane, applying a second catalyst suspension to a second side of the membrane, and drying the second catalyst suspension to form a second catalyst layer on the second side of the membrane. In some embodiments, the method also includes applying a second barrier layer, permeable to the portion of the feed that corresponds to the second catalyst but relatively impermeable to a different portion of the feed, to a side of the second catalyst layer opposite to the membrane.

The membrane is preferably a Nafion® membrane, and the catalyst suspensions are a mix of Pt—Ru and Nafion® for the anode, and a mix of Pt and Nafion® for the cathode, both of which can be directly applied to the membrane. The barrier layers preferably include both Nafion® and carbon black for the anode, and PTFE and carbon black for the cathode, and can likewise be directly applied to the dried catalyst layer. Reactant distribution layers, such as a carbon cloth, can be applied to the barrier layers by hot pressing to form a fuel cell.

The accompanying drawings, which are incorporated and constitute part of this disclosure, illustrate preferred embodiments of the invention and serve to explain the principles of the invention.

### BRIEF DESCRIPTION OF THE DRAWINGS

FIG. 1(a) is a diagram illustrating the layers of an anode supported on a reactant distribution layer for use in a mixed feed fuel cell in accordance with an embodiment of the present invention.

FIG. 1(b) is a diagram illustrating the layers of a cathode supported on a reactant distribution layer for use in a mixed feed fuel cell in accordance with an embodiment of the present invention.

FIG. 1(c) is a diagram illustrating the layers of a catalyst coated membrane in accordance with an embodiment of the present invention.

FIG. 1(d) is a diagram illustrating the layers of a mixed feed fuel cell stack in accordance with an embodiment of the present invention.

FIG. 2 is a functional diagram of an assembly sequence for fabricating a multi-cell mixed feed fuel cell stack in accordance with an embodiment of the present invention.

FIG. 3 is an illustration of an embodiment of a method for fabricating a catalyst coated membrane and complete cell in accordance with the present invention.

FIG. 4 is a graph illustrating anode polarization curves for anodes which are embodiments of the present invention wherein barrier layers of varying thicknesses are incorporated.

FIG. 5 is a graph illustrating anode polarization curves for anodes which are embodiments of the present invention wherein the barrier layers incorporate carbon loads of various amounts.

FIG. 6 is a graph illustrating current densities of anodes which are embodiments of the present invention having different carbon loadings at 600 mV.

FIG. 7 is a graph illustrating polarization curves for anodes which are embodiments of the present invention under ideal and mixed feed conditions in comparison to prior art anodes.

FIG. 8 is a table illustrating exemplarily fabrication and impedance data for anodes which are embodiments of the present invention in comparison to the prior art anode.

FIG. 9 is a diagram illustrating the layers of a prior art mixed feed fuel cell.

FIGS. 10(a) and (b) are graphs illustrating anode polarization curves for a prior art anode.

Throughout the drawings, the same reference numerals and characters, unless otherwise stated, are used to denote like features, elements, components or portions of the illustrated embodiments. Moreover, while the present invention will now be described in detail with reference to the Figs., it is done so in connection with the illustrative embodiments.

### DETAILED DESCRIPTION

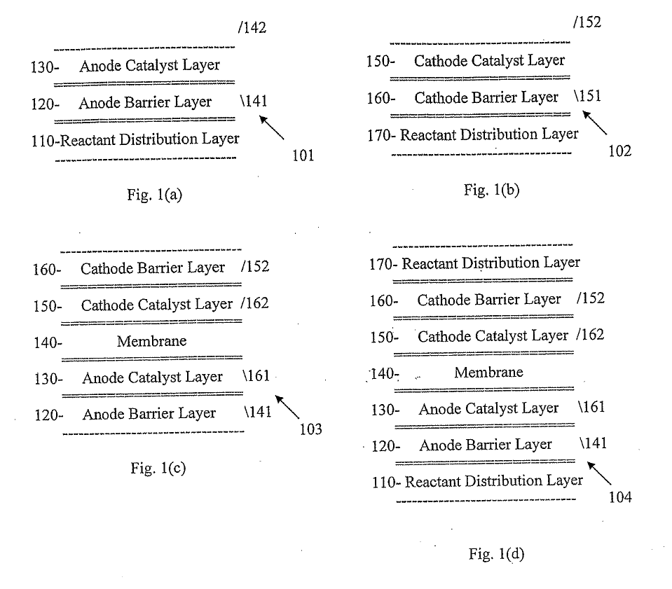

Referring to FIG. 1(a), an exemplary anode supported on a reactant distribution layer for use in a mixed feed fuel cell in accordance with the present invention is shown. Although the following will be described with respect to methanol as the fuel and oxygen as the oxidant, other fuels, such as ethanol or ethylene glycol and other oxidants such as hydrogen peroxide can be utilized, as those skilled in the art will appreciate.

The anode (101) includes an anode catalyst layer (130) having first (141) and second (142) sides, an anode barrier layer (120), permeable to methanol but relatively impermeable to oxygen, formed on the first side (141) of the anode catalyst layer (130); and a reactant distribution layer (110), formed on a side of the anode barrier layer (120) opposite to the anode catalyst layer (130).

By permeable to methanol and relatively impermeable to oxygen, it is meant that the permeability of the anode barrier layer to methanol is approximately an order of magnitude greater than its permeability to oxygen. For example, values of 2×10⁻⁶ cm²/s for the permeability of Nafion® to methanol at room temperature and 2.5×10⁻⁷ for the permeability of Nafion® to oxygen at room temperature are available.

The anode catalyst layer (130) utilizes Pt—Ru, and can also include Nafion® to bind the catalyst particles together into a film and provide ionic conduction within the catalyst layer structure. In a preferred embodiment, the anode catalyst layer (130) includes approximately 85 wt % Pt—Ru and 15 wt % Nafion® (commercially available from DuPont Fuel Cells, Wilmington, Del.). However, as those skilled in the art will appreciate, any anode catalyst, such as platinum, or a mixture of platinum and tin, may be used. Nafions is a fluorinated sulfonic acid copolymer wherein the sulfonic acid groups are fixed within the polymer matrix, yet are chemically active. Thus, Nafion® is resistant to chemical breakdown, making it useful for membranes in fuel cells.

The anode barrier layer (120) includes 1-10 mg/cm² of Nafion® loading to limit unwanted oxygen transfer to the anode, and a small amount of carbon, e.g., between 1-20 wt % carbon, to reduce ohmic resistance. In a preferred embodiment, approximately 10 wt % carbon black is added to a barrier (120) layer of 2 mg/cm² Nafion® loading. However, any substance that can withstand the operative environment of a fuel cell that is permeable to methanol but relatively impermeable to oxygen may be used to form the anode barrier layer.

Referring next to FIG. 1(b) an exemplary cathode supported on a reactant distribution layer for use in a mixed feed fuel cell in accordance with the present invention is shown. The cathode (102) includes a cathode catalyst layer (150), having first (151) and second (152) sides; a cathode barrier layer (160), permeable to oxygen but relatively impermeable to methanol, formed on the first side (151) of the cathode catalyst layer (150); and a reactant distribution layer (170) formed on a side of the cathode barrier layer (160) opposite to the cathode catalyst layer (150).

The cathode catalyst layer (150) utilizes Pt, and can also include Nafion® to bind the catalyst particles together into a film and provide ionic conduction within the catalyst layer structure. In a preferred embodiment the cathode catalyst layer (150) includes approximately 90 wt % Pt and 10 wt % Nafion®. However, as those skilled in the art will appreciate, any cathode catalyst, such as rhodium sulfide (RhS), may be used.

The cathode barrier layer (160) includes 1-10 mg/cm² of polytetrafluoroethylene loading to inhibit unwanted methanol transfer to the cathode, and a small amount of carbon, e.g., between 5-50 wt % to reduce ohmic resistance. In a preferred embodiment, approximately 25 wt % carbon black is added to a barrier (160) layer of 2 mg/cm² PTFE loading.

By permeable to oxygen and relatively impermeable to methanol, it is meant that the permeability of the cathode barrier layer to oxygen is approximately an order of magnitude greater than its permeability to methanol.

Referring next to FIG. 1(c) an exemplary catalyst coated membrane (103) in accordance with the present invention will be explained. The catalyst coated membrane includes a single membrane (140), an anode catalyst layer (130) formed on one side (161) of the membrane, an anode barrier layer (120) formed on the side of the anode catalyst layer (130) opposite to the membrane (140), a cathode catalyst layer (150) formed on a second side (162) of the membrane, and a cathode barrier layer (160) formed on a side of the cathode catalyst layer (150) opposite to the membrane.

Referring next to FIG. 1(d) an exemplary mixed feed fuel cell (104) in accordance with the present invention will be explained. The fuel cell combines the anode of FIG. 1(a) and the cathode of FIG. 1(b), and includes a single membrane (140), an anode catalyst layer (130) formed on one side (161) of the membrane, an anode barrier layer (120) formed on the side of the anode catalyst layer (130) opposite to the membrane (140), a first reactant distribution layer (110) formed on a side of the anode barrier layer (120) opposite to the anode catalyst layer, a cathode catalyst layer (150) formed on a second side (162) of the membrane, a cathode barrier layer (160) formed on a side of the cathode catalyst layer (150) opposite to the membrane, and a second reactant distribution layer (170) formed on a side of the cathode barrier layer (160) opposite to the cathode catalyst layer.

In FIGS. 1(c) and 1(d), the membrane (140) functions as a proton exchange medium. As an example, a commercially available Nafion® N1135, membrane (meaning 1100 meq/g equivalent weight, 3.5×10⁻³ inch thickness) from Ion Power (New Castle, Del.) can be utilized. Although undesirable, is somewhat permeable to methanol; however, it is relatively impermeable to oxygen.

In FIGS. 1(a), (b), and (d), the reactant distribution layers are formed of a carbon material suitable for use as such, such as carbon cloth, carbon paper, or either of these treated with a micro-porous carbon-PTFE layer. Such reactant distribution layers must consist of a chemically inert, electronically conducting, porous material. For example, the reactant distribution layers (110 and 170) may be carbon paper commercially available from Toray (New York City, N.Y.) or carbon cloth treated with a microporous carbon-PTFE layer on one or both sides, commercially available from E-TEK (Somerset, N.J.).

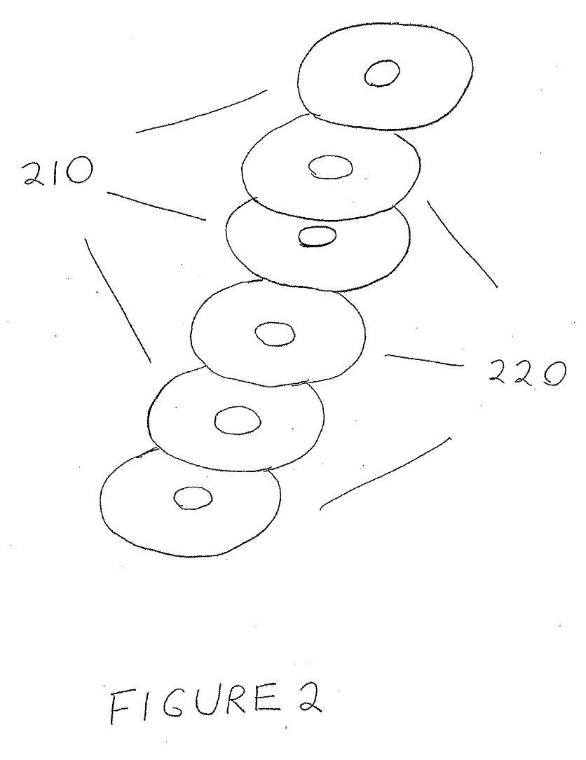

As shown in FIG. 2, fabricating a fuel cell stack involves the assembling of multiple MEAs. Several catalyst-coated membrane (CCM) layers (220) can be assembled, the CCM layers (220) incorporating the inventive barrier layer on either the anode or cathode side, or on both sides, if desired, and interspersing reactant distribution layers (210) between the CCM layers (220). Such stacking enables the production of high voltages by addition of the voltage of each cell.

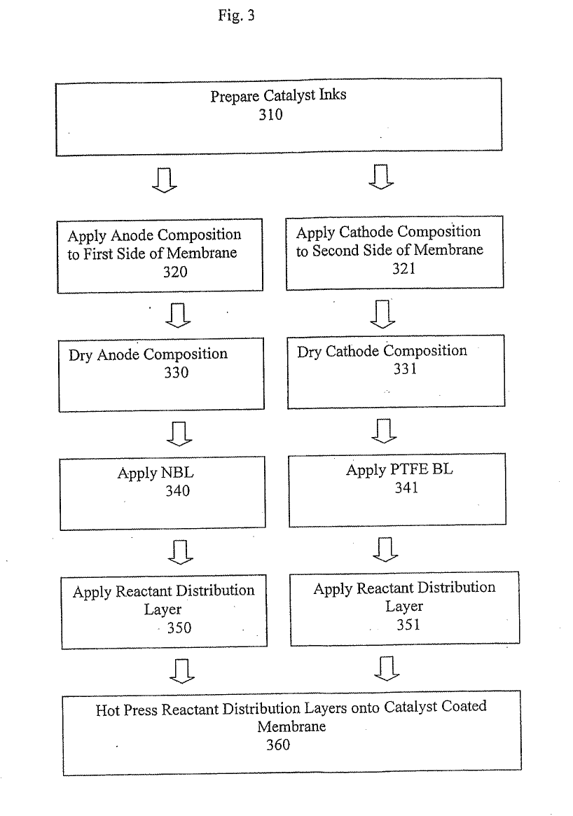

Referring next to FIG. 3, an embodiment of a method for fabricating a catalyst coated membrane for use in a mixed feed fuel cell in accordance with the present invention will be described. As shown in FIG. 3, the catalyst inks are prepared (310). These inks can be prepared by using, e.g., Pt—Ru black and Pt black suspensions in Nafion® solutions (1100 EW, 5 wt %) that are commercially available from Alfa Aesar (Ward Hill, Mass.).

To prepare catalyst inks, a Nafion® suspension can be added to water-wetted catalysts. The anode composition can be 15 wt % Nafion® and 85 wt % Pt—Ru with 6 mg/cm² nominal catalyst loading. The cathode composition can be 10 wt % Nafion®, 90 wt % Pt black with 6 mg/cm² nominal catalyst loading. The catalyst inks should be well mixed, e.g., by sonication for 60 seconds

In (320) and (321), the catalyst suspensions are applied to opposite sides of a Nafion® membrane. The suspensions can be directly applied to the membrane, preferably at approximately 60° C., and can be applied in either order. For example, as will be understood to those of skill in the art, the suspensions can be applied by painting, spraying, coating, or depositing.

In (330) and (331), the catalyst suspensions are dried, e.g., at approximately 80° C. for 1 hour on a vacuum plate.

In (340) and (341), a barrier layer is applied to the dried catalyst layer. For the anode barrier layer, a Nafion® suspension, or a mixture of Nafion® suspension with carbon black, e.g., Vulcan X72, can be directly applied to the dried electrode with desired loadings. For the cathode barrier layer, a PTFE suspension, or a mixture of PTFE suspension with carbon black, can be directly applied to the dried electrode with desired loadings.

In (350) and (351), reactant distribution layers are applied to the electrode structures. Carbon cloths can be used as reactant distribution layers for the anode and cathode, respectively. Finally, in (360), the reactant distribution layers are hot pressed with the catalyst-coated membrane, preferably at 140° C. for 5 minutes. A fiberglass shim template can be used during hot pressing to facilitate production of relatively uniform MEA thickness, improve electrode to membrane binding and increase reproducibility of the procedure.

An alternative embodiment of a method for fabricating a mixed feed fuel cell in accordance with the present invention will now be described. The method includes applying a first catalyst suspension to a first side of a membrane, drying the first catalyst suspension to form a first catalyst layer on the first side of the membrane, applying a second catalyst suspension to a second side of the membrane, and drying the second catalyst suspension to form a second catalyst layer on the second side of the membrane. A first barrier layer, permeable to the portion of the feed that corresponds to the first catalyst but relatively impermeable to a different portion of the feed, is applied to a first side of a first reactant distribution layer, and a second barrier layer, permeable to the portion of the feed that corresponds to the second catalyst but relatively impermeable to a different portion of the feed, is applied to a first side of a second reactant distribution layer. The catalyst coated membrane is then placed between two of the barrier coated reactant distribution layers, the coated reactant distribution layers arranged such that the first barrier layer on the first side of the first reactant distribution layer faces the first catalyst layer and the second barrier layer on the first side of the second reactant distribution layer faces the second catalyst layer. The assembled layers are then hot-pressed to form a cell.

In another embodiment of a method for fabricating a mixed feed fuel cell in accordance with the present invention, the method includes applying a first barrier layer, permeable to the portion of the feed that corresponds to the first catalyst but relatively impermeable to a different portion of the feed, to a first side of a first reactant distribution layer, and applying a second barrier layer, permeable to the portion of the feed that corresponds to the second catalyst but relatively impermeable to a different portion of the feed, to a first side of a second reactant distribution layer, applying a first catalyst suspension to the barrier layer side of the first reactant distribution layer, drying the first catalyst suspension to form a first catalyst layer on the first barrier layer, and applying a second catalyst suspension to the barrier layer side of the second reactant distribution layer, and drying the second catalyst suspension to form a second catalyst layer on the second barrier layer. These coated reactant distribution layers are then placed on the first and second sides of a membrane, such that the first catalyst layer of one coated reactant distribution layer faces the first side of the membrane, and the second catalyst layer of the other coated reactant distribution layer faces the second side of the membrane. The assembled layers are then hot-pressed to form a cell.

As those skilled in the art will recognize, portions of each of these methods can be utilized in combination with portions of another to form a hybridized method of fabricating a mixed feed fuel cell in accordance with the present invention.

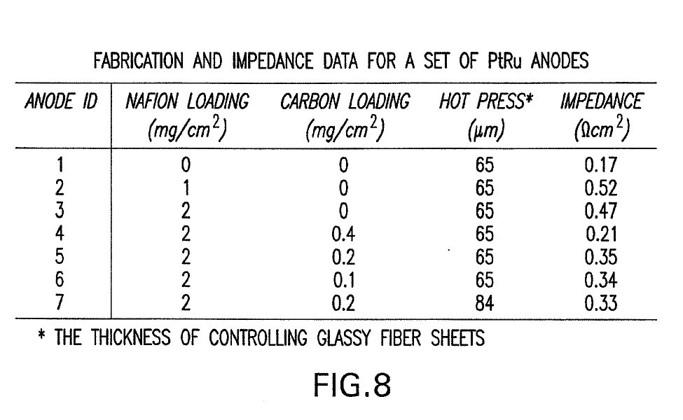

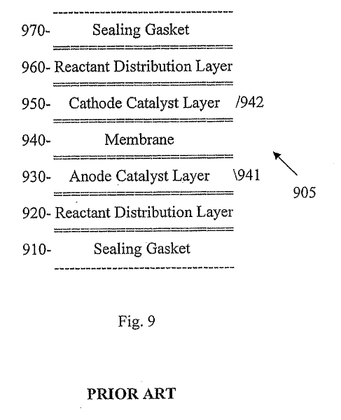

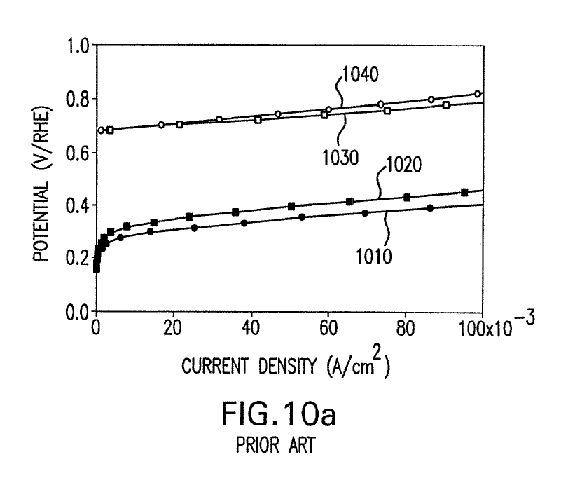

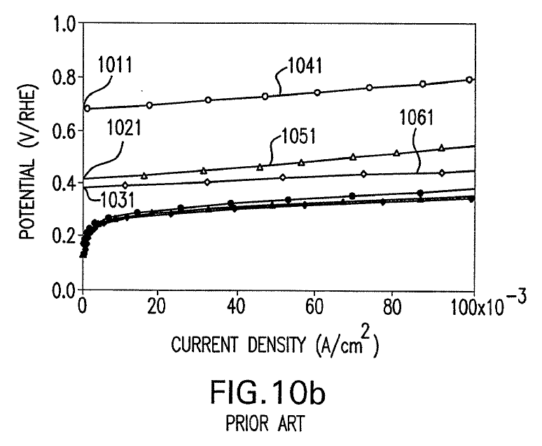

Experimental results will now be described. In the following figures and discussion, the prior art Pt—Ru anode, which has been reported in literature as a standard anode for DMFCs, is denoted as the baseline anode (Anode 1 in FIG. 8). A fuel cell testing station, commercially available from TesSol, Inc. (College Station, Tex.), was used to conduct polarization studies for the anodes. All MEAs were first subjected to 6 hours of break-in at a cell voltage of 500 mV before any polarization curves were measured. A reversible hydrogen cathode (RHE, humidified hydrogen with a flow rate of 100 ml/min) was used as reference for the anode half-cell testing. Methanol in aqueous solution (16M) was vaporized in order to add the liquid components to the gas phase. Two feed conditions were utilized in order to investigate the anode performance under ideal (a methanol solution with nitrogen) and mixed feed conditions (a methanol solution with air). The baseline operation conditions were a cell temperature of 80° C., an air (or nitrogen under ideal feed) flow rate of 56 ml/min and a methanol solution flow rate of 0.03 ml/min. A DC power supply was used to apply staircase voltages (that were larger than the open-circuit potential of the half cell) in order to measure the anode polarization curves. A vaporizer was used to evaporate methanol solution into the flowing gas at 94° C.

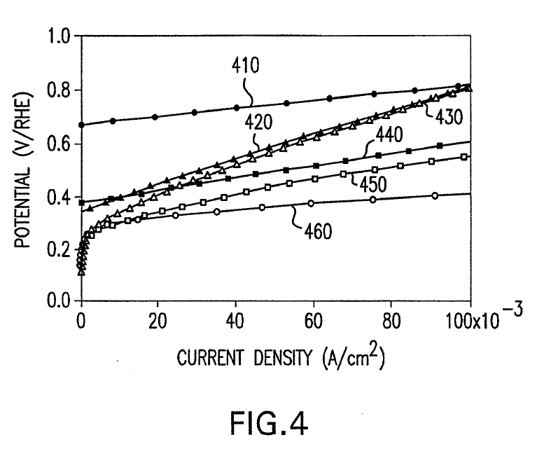

Referring next to FIG. 4, polarization curves for the anodes in accordance with the present invention, numbers 2 (represented by rectangles) and 3 (represented by triangles) of FIG. 8 are shown. The anodes have been modified with Nafion® Barrier Layers (NBL) composed of different amounts of Nafion® loading (1 and 2 mg/cm², respectively) under ideal (empty symbols) and mixed feed (solid symbols) conditions. For comparison, the data for Anode 1 (represented by circles) is also included in this figure. These Anodes 1 (460), 2 (450), and 3 (430), all show similar OCVs when oxygen is not present in the feed. However, under mixed feed conditions, the NBL modified Anodes 2 (440) and 3 (420) give an OCV of 0.37V, which is about 250 mV lower than that of the baseline anode (410), indicating that the NBL significantly improves anode performance by blocking oxygen out of the anode catalyst layer, where the possible oxygen reduction reaction (ORR) occurs. For an anode (Anode 2) with low loading (1 mg/cm²) NBL, although the OCV has been successfully dropped, there is still significant difference in anode performance under ideal (450) and mixed feed (440) conditions indicating that the NBL is not thick enough to block oxygen out of the catalyst layer. However, an anode (Anode 3) with a loading of 2 mg/cm² Nafion® in the NBL shows an ideal oxygen blocking effect, as the polarization curves for this anode under different feed conditions (430 and 420) overlap except at low current density regions (I<20 mA/cm²), from which the kinetics of methanol oxidation can be clearly seen when the mixture of methanol and nitrogen is fed. Compared to the polarization curves for the baseline anode, the NBL modified anodes have a high ohmic resistance as evidenced by the steep slope of their polarization curves, as well as by their high frequency impedance: 0.52 and 0.47 Ω·cm² for Anode 2 and Anode 3, respectively, which are two times higher than the baseline anode. This increase in impedance can be explained by the addition of the Nafion® material, because Nafion® is not electrically conductive.

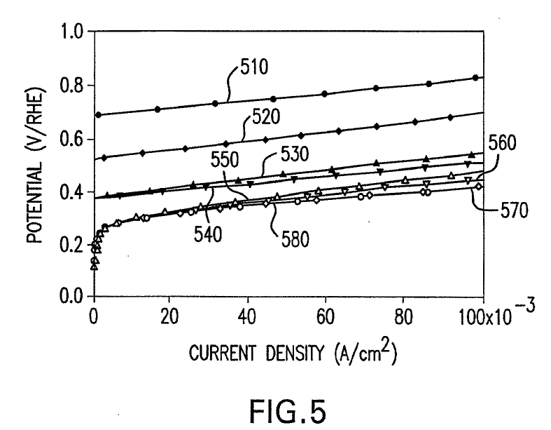

One way of lowering the ohmic resistance of the NBL modified anode is to add carbon black, which is electrically conductive, to the NBL, forming a Nafion®/Carbon Barrier Layer (NCBL). Referring to FIG. 5, polarization curves of four different anodes are shown: the baseline Anode 1 (represented by circles) and three NCBL modified Anodes 4 (represented by diamonds), 5 (represented by reversed triangles), and 6 (represented by triangles), with different carbon loadings of 0.4, 0.2 and 0.1 mg/cm², respectively.

The addition of 0.4 mg/cm² of carbon to the NBL slightly improves anode performance (Anode 4) under mixed feed conditions (520) (represented by solid symbols) by decreasing the OCV from 0.62 to 0.53V while maintaining similar ohmic resistance to the baseline anode (510). It is clear that carbon does have the intended effect of increasing the conductivity of the barrier layer as evidenced by the lower impedance (0.21 Ω·cm²), compared to that of the NBL modified anodes (˜0.5 Ω·cm²). Reducing the carbon loading to 0.2 mg/cm² (Anode 5) (540) further improves the anode performance although the impedance of this anode (0.35 Ω·cm²) is somewhat higher than that of Anode 4. However, the performance of Anode 6 (530), a NCBL modified anode with a carbon loading of 1 mg/cm², is inferior to Anode 5 (540), as shown in FIG. 5. For comparison, the performance of Anodes 1 (580), 4 (570), 5 (560), and 6 (550) are shown under ideal feed conditions (represented by empty symbols).

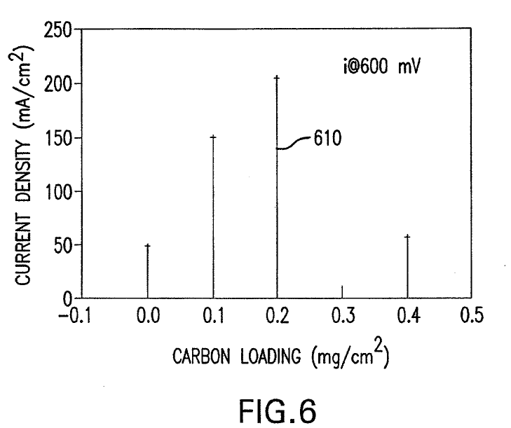

The current densities for the NCBL modified anodes at 600 mV are presented in FIG. 6, which shows that the anode performance is maximized under mixed feed conditions when 0.2 mg/cm² carbon loading is used (610). Although higher carbon content increases the conductivity of anode, it also increases the oxygen permeability through NCBL since more pathways are created for oxygen diffusion if an excess amount of carbon exists in the layer. On the other hand, a too-low amount of carbon in the NCBL is not sufficient to create good electric conductivity for the MEA, which compromises the anode performance due to a higher ohmic resistance. There is therefore an optimal carbon content (0.2 mg/cm²) in the NCBL at which oxygen permeability and electrical conductivity are well balanced to obtain a maximum anode performance under mixed feed conditions.

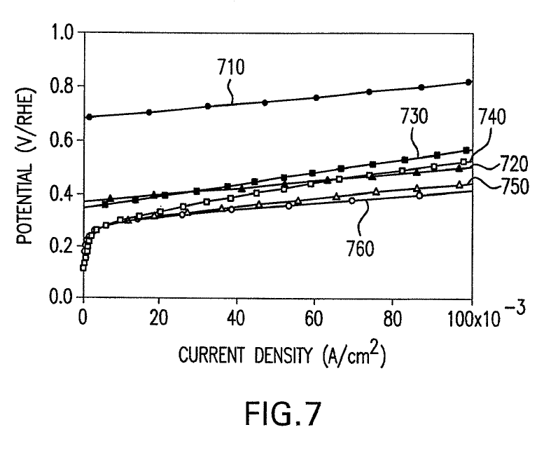

Some operating conditions during MEA fabrication process significantly affect the performance of a NCBL modified anode. Among them, hot pressing plays a decisive role in affecting the ohmic resistance of a MEA. Referring to FIG. 7, polarization curves for two NCBL modified anodes, Anode 5 (720 and 750) and Anode 7 (730 and 740) under mixed feed and ideal feed conditions, respectively, having identical NCBLs but different hot pressing conditions are shown. It can be seen that less hot pressing strength results in inferior anode performance, as evidenced by smaller current densities exhibited by the resulting anode as compared to a standard pressed anode at an identical operating voltage both under ideal and mixed feed conditions. However, the OCVs for these two anodes are identical, showing that they initially have similar oxygen-blocking performance. This difference in anode performance is likely caused by more physical contacts among carbon particles in the NCBL for the standard hot pressed anode, which enhances the conductivity of the NCBL modified anode, as opposed to the anode fabricated using less hot pressing strength. For comparison, the polarization curves of the baseline Anode 1 under ideal feed (760) and mixed feed (710) conditions are also presented.

FIG. 8 presents a table of the fabrication and impedance data for Anodes 1-7 explained with reference to FIGS. 4-7.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

1. An electrode for use in a mixed feed fuel cell, wherein said mixed feed comprises a fuel portion and an oxidant portion, comprising;
a barrier layer, having first and second sides, permeable to one of said fuel portion and said oxidant portion of said mixed feed, and relatively impermeable to a different one of said fuel portion and said oxidant portion of said mixed feed;
a catalyst layer, formed on said first side of said barrier layer; and
a reactant distribution layer, formed on said second side of said barrier layer.

2. The electrode of claim 1, wherein said electrode is an anode, said catalyst layer is an anode catalyst layer, and said barrier layer is relatively permeable to said fuel portion of said mixed feed and relatively impermeable to said oxidant portion of said mixed feed.

3. The electrode of claim 2, wherein said barrier layer comprises Nafion®.

4. The electrode of claim 3, wherein said barrier layer comprises between 1 and 10 mg/cm² Nafion®.

5. The electrode of claim 3, wherein said barrier layer further comprises carbon black.

6. The electrode of claim 5, wherein said barrier layer comprises between 1 and 20 wt % carbon black.

7. The electrode of claim 1, wherein said electrode is a cathode, said catalyst layer is a cathode catalyst layer, and said barrier layer is relatively permeable to said oxidant portion of said mixed feed and relatively impermeable to said fuel portion of said mixed feed.

8. The electrode of claim 7, wherein said barrier layer comprises polytetrafluoroethylene.

9. The electrode of claim 8, wherein said barrier layer comprises between 1 and 10 mg/cm² polytetrafluoroethylene.

10. The electrode of claim 8, wherein said barrier layer further comprises carbon black.

11. The electrode of claim 10, wherein said barrier layer comprises between 5 and 50 wt % carbon black.

12. A method of making a catalyst-coated membrane for use in a mixed feed fuel cell for generating electricity from a mixed feed, wherein said mixed feed comprises a fuel portion and an oxidant portion, comprising:
(a) applying a catalyst suspension to a side of a membrane;
(b) drying said catalyst suspension to form a catalyst layer having first and second sides, said first side contacting said side of said membrane; and
(c) applying a barrier layer, permeable to one of said fuel portion and said oxidant portion of said mixed feed, and relatively impermeable to a different one of said fuel portion and said oxidant portion of said mixed feed, to said second side of said catalyst layer.

13. The method of claim 12, wherein said catalyst is an anode catalyst and said barrier layer is an anode barrier layer.

14. The method of claim 13, wherein said anode barrier layer comprises Nafion®.

15. The method of claim 12, wherein said catalyst is a cathode catalyst and said barrier layer is a cathode barrier layer.

16. The method of claim 15, wherein said cathode barrier layer comprises polytetrafluoroethylene.

17. A fuel cell for generating electricity from a mixed feed including fuel and an oxidant, comprising:
a membrane having first and second sides,
an anode catalyst layer, formed on said first side of said membrane;
a first reactant distribution layer, formed on said anode catalyst layer opposite to said membrane;
a cathode catalyst layer, formed on said second side of said membrane;
a second reactant distribution layer, formed on said cathode catalyst layer opposite to said membrane; and
at least one barrier layer selected from the group consisting of:
(i) an anode barrier layer, permeable to said fuel and relatively impermeable to said oxidant, formed in between said anode catalyst layer and said first reactant distribution layer, and
(ii) a cathode barrier layer, permeable to said oxidant and relatively impermeable to said fuel, formed in between said cathode catalyst layer and said second reactant distribution layer.

18. The mixed feed fuel cell of claim 17, wherein said at least one barrier layer is an anode barrier layer, permeable to said fuel and relatively impermeable to said oxidant, formed in between said anode catalyst layer and said first reactant distribution layer.

19. The mixed feed fuel cell of claim 17, wherein said at least one barrier layer is a cathode barrier layer, permeable to said oxidant and relatively impermeable to said fuel, formed in between said cathode catalyst layer and said second reactant distribution layer.

20. The mixed feed fuel cell of claim 17, wherein said mixed feed fuel cell includes at least an anode barrier layer, permeable to said fuel and relatively impermeable to said oxidant, formed in between said anode catalyst layer and said first reactant distribution layer, and a cathode barrier layer, permeable to said oxidant and relatively impermeable to said fuel, formed in between said cathode catalyst layer and said second reactant distribution layer.
